(19) United States
(12) Patent Application Publication
(10) Pub. No.: US 2009/0319300 A1
(43) Pub. Date: Dec. 24, 2009

(54) METHOD AND SYSTEM FOR PROVIDING CLINICAL DECISION SUPPORT

(75) Inventor: Dosto Manakkil, Ernakulam (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, SCHENECTADY, NY (US)

(21) Appl. No.: 12/144,710

(22) Filed: Jun. 24, 2008

(51) Int. Cl. G06Q 10/00; G06Q 50/00; G06F 17/30; G06F 7/06

(52) U.S. Cl. 705/3; 705/2; 707/104.1; 707/3; 707/E17.005; 707/E17.014

(57) ABSTRACT

A method and system for providing clinical decision support is disclosed herein. The method comprises: mapping medication information with at least one follow up action based on a predefined relation. The follow up actions are suggested to a user upon selecting a medication formation. The method further includes scheduling the follow up actions may automatically.

### FIELD OF THE INVENTION

This invention relates generally to clinical workflows, and more particularly to, a method and system for associating medication information with related follow up actions.

### BACKGROUND OF THE INVENTION

While clinicians are receiving medical training, some one will be guiding them in diagnosis. However upon completion of medical training and during the initial phase of their medical practice, clinicians might benefit from some kind of support while making clinical decisions. For example, along with some medications there is a recommended follow up action associated with it. Due to inexperience the clinicians may miss suggesting the recommended follow up actions. It will be beneficial to remind or suggest the clinician about the follow up actions.

Also, even experienced clinicians might be very busy and might be doing different tasks simultaneously. Due to their hectic schedule they might forget to suggest the related follow up actions for a prescribed medication. For example, after taking a particular medication it might be required to get a lab test done and, based on the results, the clinician might need to change the medication. In this event, it is essential to suggest the follow up action and missing that might result in a serious lapse in patient care.

Generally when a patient is discharged, a discharge handout is given to the patient indicating various details, including the details of any prescribed medications, the clinician's prescriptions and any corresponding follow up actions for those medications. It is possible that the administrator or clinical assistant who prepares the discharge handout may forget to attach the follow up actions for one or more of the medications.

Further, even after receiving indication about the recommended follow up actions, the patient might forget to attend to the follow up actions. He might forget to schedule the follow up action or might miss the appointment after scheduling the same. It will be beneficial to automatically schedule and remind about the follow up actions to ensure that the patient attends the follow up actions suggested by the clinician.

Thus there exists a need to provide a method and system to improve patient care by properly suggesting and scheduling various follow up actions associated with a medication information.

### SUMMARY OF THE INVENTION

The above-mentioned shortcomings, disadvantages and problems are addressed herein which will be understood by reading and understanding the following specification.

One embodiment of the present invention provides a computer implemented medical decision support method. The method comprises: mapping medication information with at least one follow up action based on a predefined relation.

In another embodiment, a computer implemented prescription support method is disclosed. The method comprises: prescribing medication information; accessing at least one related follow up action from a database based upon the prescribed medication information; and indicating the follow up actions relevant to the prescribed medication information.

In yet another embodiment, an automated clinical decision support system is disclosed. The system comprises: a processor for mapping medication information with corresponding follow up actions based on their relation; and an indicator for indicating the corresponding follow up actions upon selecting a medication information.

In yet another embodiment, an integrated patient care system is provided. The system comprises: a database configured to include patient information; a data map configured to link various medication information with follow up actions based on a predefined relation; a processor configured to access follow up actions corresponding to a prescribed medication information from the data map; an interface for facilitating interaction of the processor with the data map; and a display for displaying the accessed follow up actions.

In yet another embodiment, the invention provides a computer-readable medium having one or more computer readable media for providing decision support. The medium comprises: a routine for mapping medication information with follow up actions based on at a predefined relation; and a routine for accessing the related follow up actions upon selecting at least one medication information.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram indicating a method of linking various medication information with follow up actions as described in an embodiment of the invention;

FIG. 2 is a flowchart illustrating a clinical decision support method as described in an embodiment of the invention;

FIG. 3 is a block diagram of an automated clinical decision support system as described in an embodiment of the invention;

FIG. 4 is a block diagram of an integrated patient care system as described in an embodiment of the invention;

FIG. 5A to FIG. 5F show a diagrammatic representation of a method of providing decision support to a clinician as described in an embodiment of the invention; and

FIG. 6A to FIG. 6I show a diagrammatic representation of an improved clinical workflow as described in an embodiment of the invention;

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Embodiments of the present invention improve the accuracy and efficiency of the everyday tasks of diagnosing, collaborating and scheduling among a plurality of clinicians, healthcare providers, staff, administrators, patients and family members of patients across a single healthcare system or a network of healthcare systems. To do this, an exemplary embodiment of the present invention utilizes a method of associating medication information with related follow up actions.

In various embodiments, a computer implemented method and system for clinical decision support is disclosed. The method or system links various medication information with follow up actions based on a predefined relation. Upon selecting or suggesting a medication information, related follow up actions are indicated to a user. In an example, the user includes a clinician or a clinical assistant. This ensures that a clinician suggests the relevant follow up actions to a patient.

In an embodiment, the related follow up actions are accessed and are scheduled automatically. The clinical assistant or administrator is provided with related follow up actions and based on the feedback from the patient or the caretaker, the follow up actions are scheduled. This ensures that the patient has been promptly reminded of the follow up actions.

In an embodiment, a method and system for ensuring improved patient care is suggested. In one aspect, the method suggests reminding users including clinician or an administrator to suggest follow up actions related to the suggested medication. In another aspect, by linking the follow up actions with the scheduling, it is ensured that the patient is reminded of their follow up actions.

In an exemplary embodiment, a database is populated with different medication information and corresponding follow up actions. This is done based on various rules. In an example, this database is associated with an Electronic Medical Record (EMR) or Electronic Health Record (EHR). In an embodiment, the user is given an opportunity to customize the database or the rules.

In an embodiment, a decision support system is disclosed. The system provides related follow up actions to a clinician to ensure that the clinician suggests all the relevant follow up actions along with a medication.

In an embodiment, a fully automated patient care system is proposed. The system is configured to automatically assign the follow up actions and schedule various follow up actions.

The term “medication information” referred in the specification refers to a list of clinical information unless otherwise specified. Similarly the term “follow up actions” refers to actions that need to be taken after a medical diagnostics or treatment suggested by the clinician. The examples of the medication information and the follow up actions and the relation between the same need not be limited to the examples mentioned in the specification.

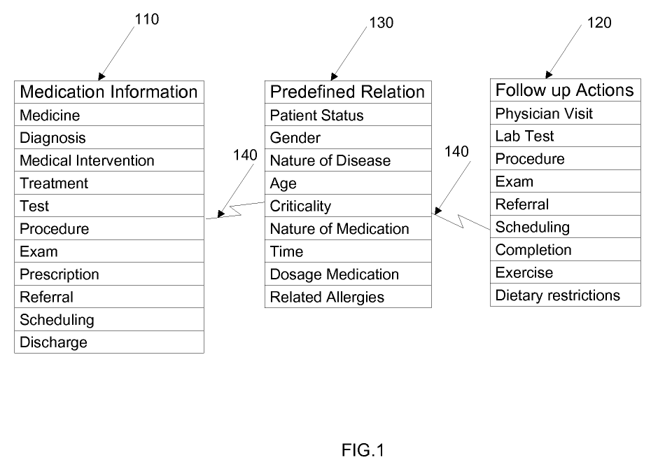

FIG. 1 is a diagrammatic representation of a method linking various medication information with follow up actions as described in an embodiment of the invention. In an embodiment shown, medication information 110 is listed of medication information such as a medicine, a diagnosis, a medical intervention, a treatment, a test, a procedure, an exam, a prescription, a referral, a scheduling of an appointment, a completion of an appointment, and a discharge. However the medication information 110 need not be limited to these. A list of follow up actions represented by reference numeral 120 indicate a list of actions that needs to be followed subsequent to the suggestion of particular medication information. The follow up actions 120 could include a physician visit, a lab test, a procedure, an exam, referral, a scheduling of an appointment, a completion of an appointment, an exercise and a dietary restriction. A link 140 is established between the medication information 110 and corresponding follow up actions 120, using at least one predefined relation 130. The predefined relations 130 could include one or generally a plurality of rules based on at least one of patient status, gender, nature of disease, age, criticality of the disease, nature of medication, time period and dosage of medication.

In an embodiment, the link 140 may be established in real time upon selecting medication information 110. This is done using at least one predefined relation 130 between the medication information 110 and the follow up actions 120. Alternately, a database may be generated linking general medication information along with the corresponding follow up actions and can be assessed as and when its required.

In an embodiment, the mapping could be one done in one of many different formats. A medication information 110 may be related to one or more follow up actions 120. Similarly a follow up action 120 may be recommended upon suggesting more than one medication information 110. Thus the link 140 between the medication information 110 and the follow up actions 120 can follow a “one to one”, “one to many” or “many to many” format.

In an example, the predefined relation or the associated rules may be customized. A clinician or an administrator may modify or alter the predefined relation 130. In an example, the alteration may be done to make the mapping patient specific. Some times all the patients below a certain age require a follow up after a certain medication is prescribed; in this event a clinician may define the relation accordingly.

In an exemplary embodiment, the linked medication information 110 and follow up actions 120 are made available to other departments, so that it can act as a source of reference while suggesting medication by the clinicians from other departments. For example, consider a patient who has a tendency for a particular symptom or allergy and requires some follow up actions for medicines having a certain chemical compound. By accessing the database, clinicians from other departments may learn about this and may avoid suggesting medicines having that particular compound or suggest the same follow up actions. Similarly, this could be applied at a generic level rather than at patient level.

Further the database or the association of medication formation with the follow up actions may act as a base for research on various clinical studies. The link 140 between certain medication information 110 and follow up actions 120 may be analyzed and can used to reach a certain conclusion. For example, clinical study for patients of a certain race or region may be performed by accessing the medication information and related follow up action suggested by the clinician. From this, certain conclusion about their clinician pattern may be established.

Also a comparison study may be done with the follow up actions suggested automatically and the actual follow up suggested by the clinician or the actual follow up actions undergone by the patient.

Further the method of linking medication information with the follow up actions could be used as an educational tool for the patient or for the caretaker. For example, if the patient is detected with certain symptoms, after a certain medication, the system may suggest certain follow up actions, such as visiting the clinician immediately, reducing the dosage of medication or conducting any test. Thus rather than suggesting the actual follow up immediately after medication, the user may be prompted to enter various reactions on the patient due to suggested medication and based on the same, follow up actions may be suggested. In an example, before suggesting the follow up action, the system may consult with the clinician.

An embodiment of the invention provides a fully automated follow up suggestion system. The system tracks the medications taken by the patient and is configured to track the symptoms of the patient after taking the medication. The patient or a caretaker may enter the symptoms of the patient to the system. The system is configured to link various symptoms associated with a medication to corresponding follow up actions. For example, if the patient is identified with having the symptom of a “fever”, even after taking three days of medication, the system may associate these symptoms to a follow up action such as “a lab test”. The system may also inform the clinician about the follow up action and seek his opinion. Thus various symptoms of a patient after a medication can also be linked to various follow up actions.

Further the method ensures an increase in revenue and patient care by ensuring that required follow up actions are suggested promptly and ensures that patient follows these actions by automatically scheduling them.

An embodiment of the invention addresses the lack of automating suggestion of follow up actions and scheduling the suggested follow up actions. The relevant follow up actions are proposed and suggested by the clinician and the actions are scheduled automatically. This facilitates tracking clinicians, administrators, healthcare provides and patients on various follow up action and the services provided by them. The tracking may be done patient specific to track how regularly patient takes the follow up actions and necessary advice may be given if they skip the follow up actions. Further tracking may be done based on medication information or follow up actions, how frequently that medication is suggested and how many times corresponding suggested follow up actions were relevant.

An embodiment facilitates efficient follow up actions such as lab tests, treatments, referrals etc. This could be achieved by generating an electronic report. The clinician or the administrator can generate a report and inform the lab technicians or reference clinicians about the follow up actions, so that the follow up actions can be done more efficiently. Similarly, the lab results or the opinion of referral clinicians may be sent to the clinician automatically, as and when the test or opinion is complete and this avoids delay in providing the treatment and enhances efficiency.

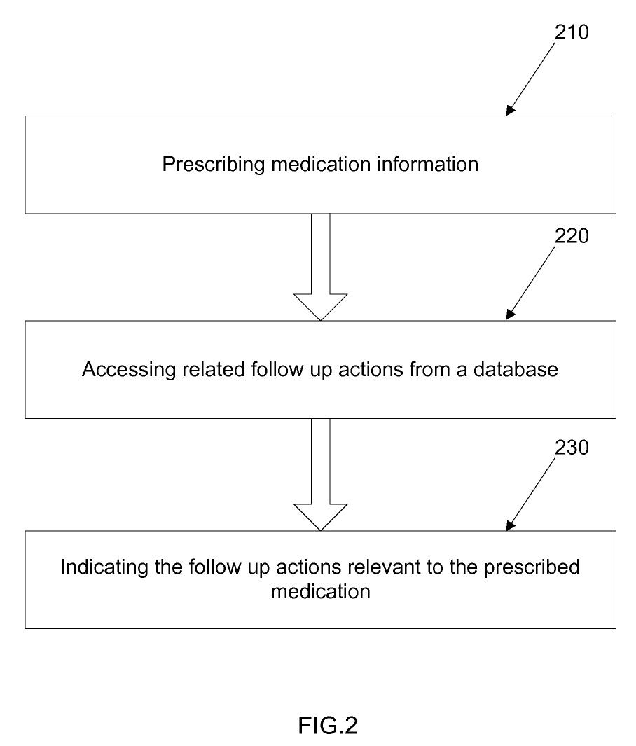

FIG. 2 is a flowchart illustrating a clinical decision support method as described in an embodiment of the invention. At step 210, a medication information is prescribed by a clinician. The clinician may prescribe a new medication or may select from a list of available medication information. A list of available medication may be displayed to the clinician. Alternately if the clinician specifies the disease or symptoms, a list of relevant medicines may be displayed so that the clinician can select it from the list. At step 220, related or recommended follow up actions are accessed from a database. This is done by accessing a database or record that is provided with various medication information and related follow up actions. Alternately a link may be established with follow up actions in real time upon prescribing medicines. Several rules may be used for linking the patient information with the follow up. In an embodiment, a clinician or a clinical assistant may customize the database based on requirements. At step 230, the accessed follow up actions are indicated. If a clinician is prescribing the medication, the follow up actions are indicated to the clinician. The related follow up actions may be indicated visually or audibly. If a clinical administrator is involved, list of follow up actions may be displayed to the administrator, so that the follow up actions can be associated with the discharge summary. In another embodiment, the actions are indicated to the patient.

In an embodiment, the follow up actions may be linked to the scheduling information. The scheduling of the follow up actions can be done automatically. The follow up actions can be scheduled at the time of prescribing medication or while the discharge handout is being handed over to the patient or to the caretaker. For example, at the time of discharge, a patient or caretaker may be enquired whether they need to schedule the follow up actions and if so, how the scheduling information is has to be communicated to him. This will ensure that if a patient misses the appointment for a follow up action, its because of his choice and not by mistake.

In an embodiment, patient information could be mapped against follow up actions. For example, the follow up action may be specific to a patient. If a patient is having allergy to some medicine that can be listed along with the follow up action specific to the patient, so that as and when the doctor prescribes the medicine, proper precaution may be taken against allergy or alternate medication can be given.

In an embodiment, clinical symptoms may be mapped with follow up actions. This may be for a patient or a generalized database could be formed. The clinical symptoms may be taken before or after taking the medication information.

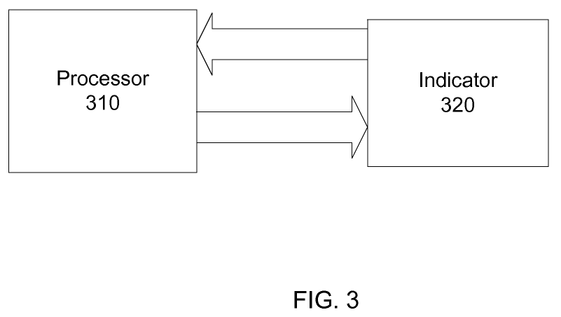

FIG. 3 is a block diagram of an automated clinical decision support system as described in an embodiment of the invention. In an embodiment, the system is configured to assist a clinician in making clinical decisions. The decision support system is configured to include a processor 310 and an indicator 320. The processor 310 is configured to link various medication information with various follow up actions based on a predefined relation. The processor 310 may be any processor capable of use with a computer implemented system. In an example, the processor 310 is configured to generate a lookup table having various medication information with corresponding related follow up actions. Alternately the processor 310 may fetch the corresponding follow up actions from a database having this information. The indicator 320 is configured to indicate the relevant follow up action along with or without the medication information. The indicator 320 may be a visual display or an audio indicator or a device capable of communicating this information to an external device or to a user. The processor 310 is configured to map the medication information with follow up actions using a set of rules based on at least one predefined relation. This rule can be defined by a user or may be modified based on the patient requirements. In an example, the processor 310 may be configured to fetch the medication information from an external database or from an external memory device.

The indicator 320 may be a user interactive display configured to display a set of medication information and a user can select the medication information from the display. Thus the display is configured to act as a user interface for interacting with the processor or to control the processor. Alternately any user interface may be attached with the indicator 320 for interacting with the processor 310. The processor 310 is configured to customize or alter the rules or predefined relations based on which the mapping is performed.

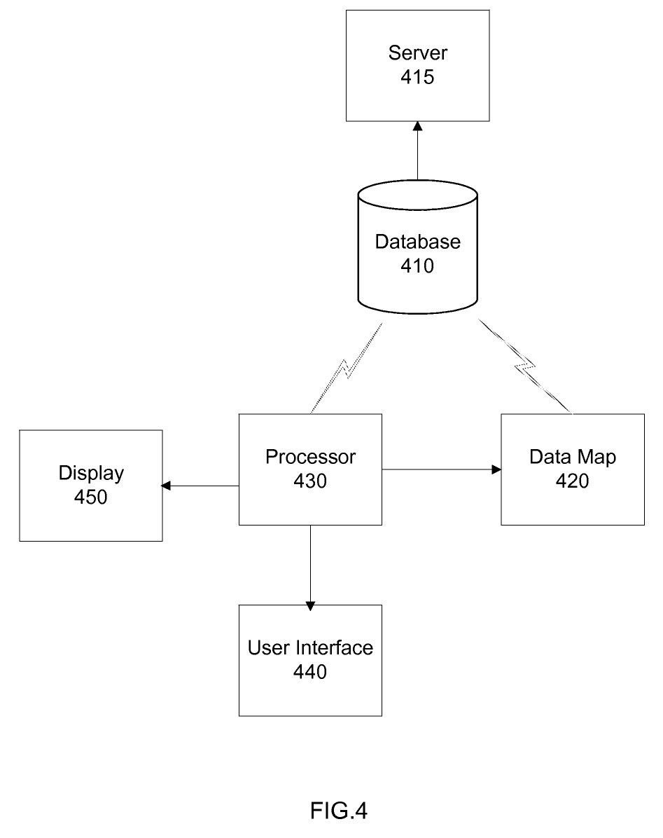

FIG. 4 is a block diagram of an integrated patient care system as described in an embodiment of the invention. The integrated patient care system, referred herein after as system includes a database 410 configured to include patient information. The patient information might include name, age, gender, contact information, clinician information etc, but need not be limited to this. The database 410 may be an integrated part of the patient care system, or the database may be fetched or accessed from an external source. The database 410 may also be provided in the form of readable memory devices, such as compact discs, pen drives, etc. The system is configured to include a data map 420, indicating mapping or association or linking between various medication information and follow up actions. The data map 420 may be accessed from an external device to the integrated patient care system by a processor 430. Alternately the processor 430 may generate a data map 420 linking various medication information with the follow up actions based on a predefined relation. The processor 430 may access the data map 420 based on commands received from a user interface 440. The user may control the processor 430 based on his requirements through the interface 440. The interface 440 may be a wireless or wired interface. The integrated system is configured to include a display 450 to indicate the selected follow up actions.

In an embodiment, the database 410 stored with patient information is populated with the medication information. The database 410 configured to include patient information is accessed to the system and medication information is also accessed to the system. In an embodiment, the patient prescription indicating the medication information may be accessed to the system electronically. Alternately a list of medication information may be displayed to a clinician from which the clinician can select the desired medication information.

In an embodiment, the processor 430 is configured to select the displayed follow up actions automatically. Alternately, the desired follow up actions may be displayed to the clinician so that the clinician can select the follow up actions required for the patient.

In an embodiment, the system is configured to associate follow up action with the discharge handover. Generally at the time of discharge, a patient is given a discharge handover indicating the details of prescription indicating medication information and corresponding follow up actions. The corresponding follow up actions may be accessed automatically and attached to the discharge handover. Similarly the medication information or the prescription information may be fetched from a database or a clinician's computer.

In an embodiment, the clinician or administrator may schedule the follow up actions automatically. The administrator while preparing the discharge handout, the required follow up actions are added and are scheduled to ensure that the patient attends the follow up actions. The scheduling may be done at the convenience of the patient or the caretaker. The patient or the care taker can choose the mode of communication by which the reminders should be send to them indicating the follow up actions. The communication may be sent through an electronic mail message, a pager message, a telephone communication, a cellular telephone communication, a facsimile communication, an instant message and a pop-up window communication. Also certain arrangements can be made for the informing the healthcare service providers or referral clinician about the scheduled appointment.

In an embodiment, the processor 430 not only performs the scheduling, but also updates the status of the follow up actions as and when the follow up action is performed. For example, when the patient completes a lab test, the same can be updated in the system, so that subsequent reminders can be avoided.

The database 410 can be a part of a server 415 such that the follow up actions, prescription and their status can be updated in a common database or record, so that relevant information with respect to a patient is available. The accessibility of this information can be restricted as this includes lots of confidential information.

In en embodiment, the processor 430 links the data map 420 with an Electronic Medical Record (EMR) or Electronic Health Record (EHR), so that the mapped information is available to a group of people.

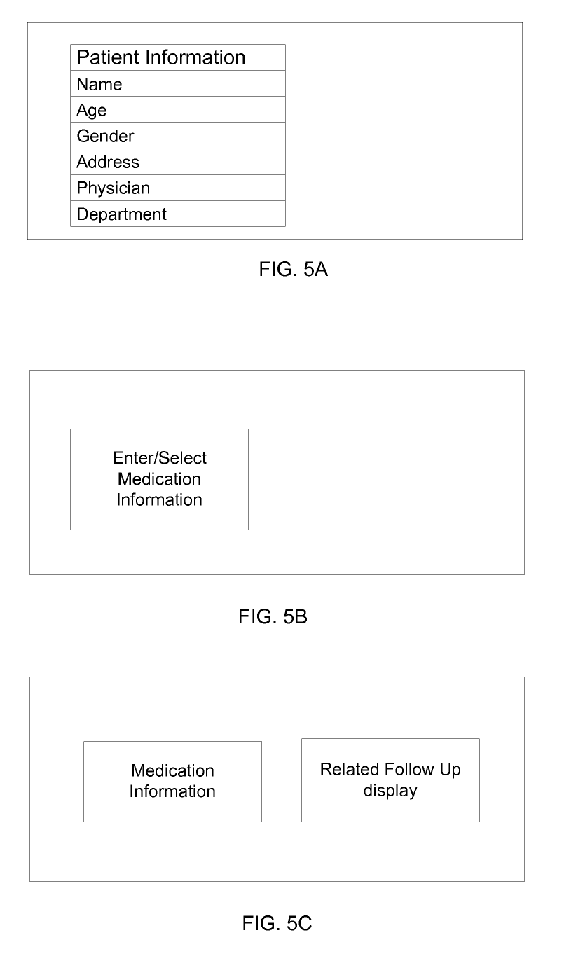

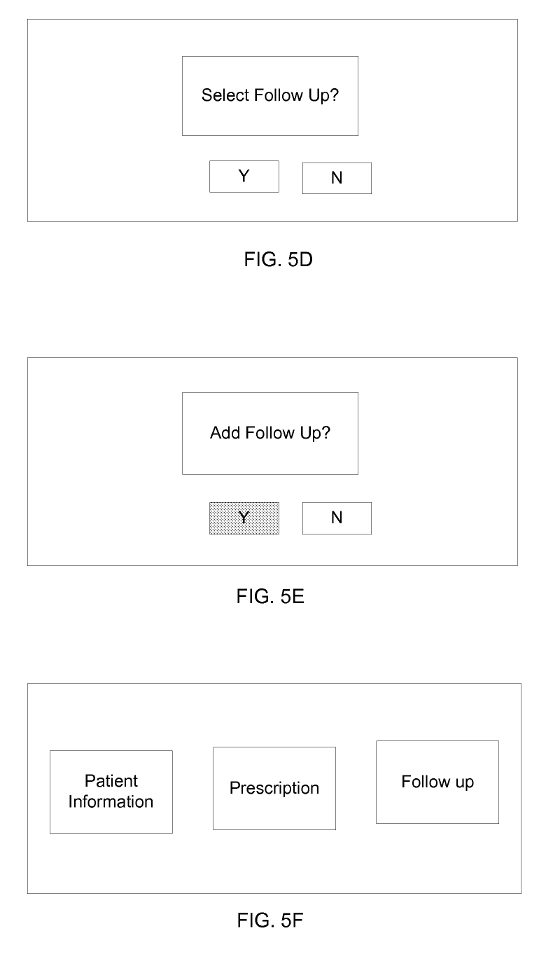

FIG. 5A to FIG. 5F show a diagrammatic representation of a method of providing decision support to a clinician as described in an embodiment of the invention. In FIG. 5A a list of patient information is displayed to the clinician. The patient information could be a part of a patient record. This is to identify the patient and the clinician may also be provided with the previous health records and history of the patient. After the diagnosis, the clinician enters or selects the medication information, as shown in FIG. 5B. A list of medication information may be displayed on the display so that the clinician can select or enter the desired medication information. In an example, the clinician may specify the disease and recommended medication may be displayed on a display. The clinician through a user interface may select the desired medication information. Alternately, the clinician may type in the desired medication. Upon entering the medication information a list of follow up actions are displayed to the clinician as shown in FIG. 5C. These follow up actions are linked to the medication information based on a predefined relation. Hence follow up actions related to the suggested medication information is displayed to the clinician. At FIG. 5D an additional check is made before adding the follow up actions to the prescription information or to the patient record. This is an optional step. Alternately the clinician may directly select and add the follow up action to the patient record. At FIG. 5E the clinician agrees to add the follow up actions to the patient record. The follow up actions are added to the patient record and displayed along with the patient information, prescription and the related follow up actions as shown in FIG. 5F.

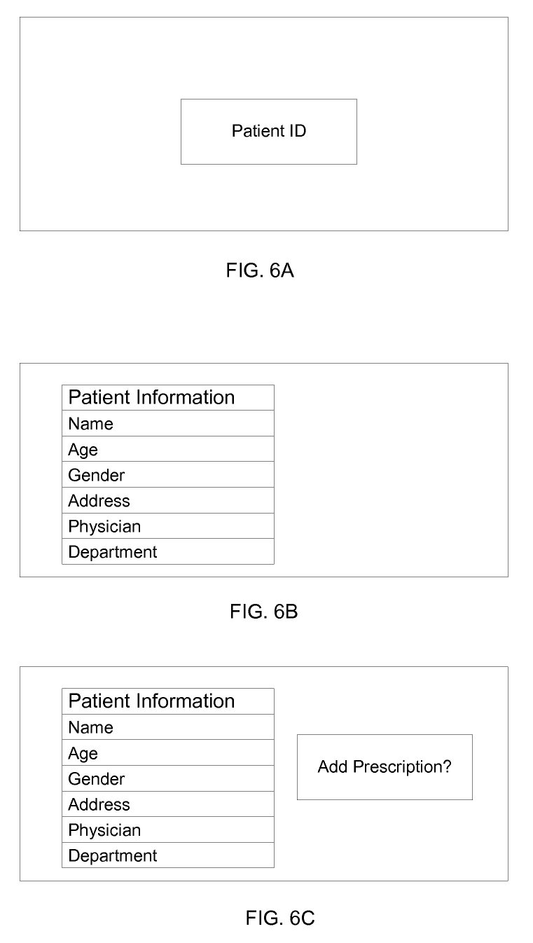

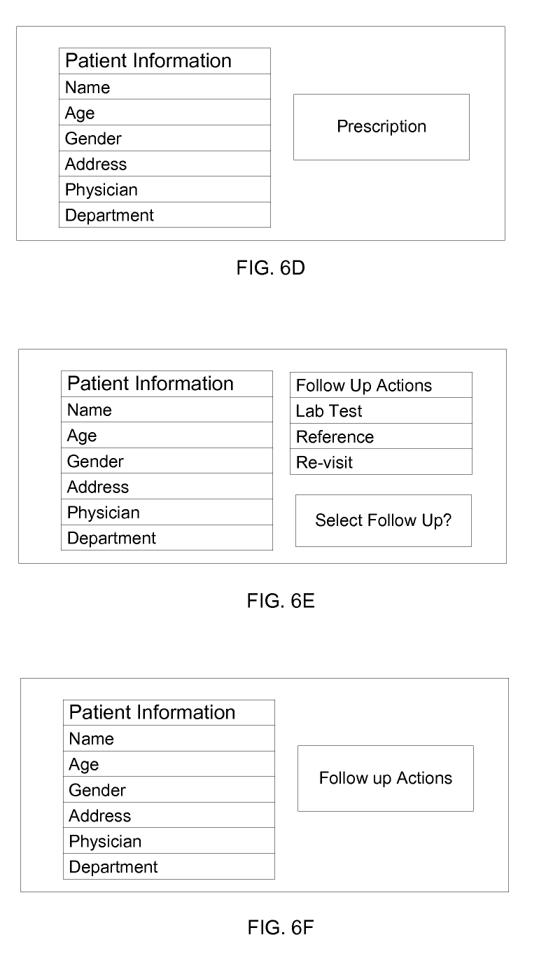

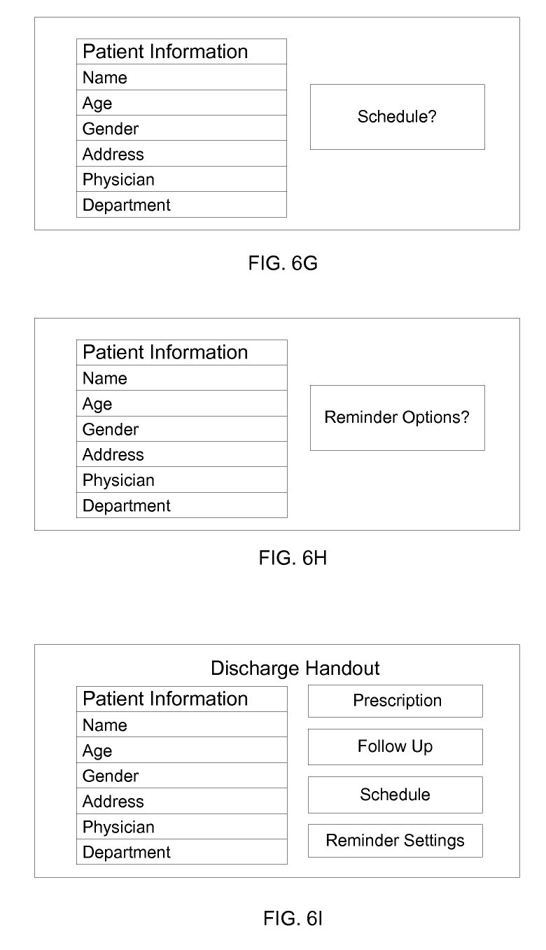

FIG. 6A to FIG. 6I show diagrammatic representation of an improved clinical workflow as described in an embodiment of the invention. In an exemplary embodiment, the workflow is explained with reference to a patient administration workflow. An administrator gives a discharge handover to a patient at the time of discharge. In FIG. 6A an administrator is prompted to enter a patient identification parameter such patient ID (identification) number, registration number, etc. In FIG. 6B, a list of patient information is displayed. Upon entering the patient ID or any other patient identifying information, the patient information is displayed to the administrator. This information may be fetched from a hospital server, using a wireless or wired link. Or the administrator's computer may be stored with this information. In FIG. 6C, the administrator is prompted to add the prescription information to the patient record. The patient may carry the prescription along with him or the clinician may send the prescription to the administrator or the prescription information may be fetched from a clinician's computer or from any database associated with it. Upon adding the prescription to the patient record, the prescription details indicating the medication information is added to the patient record, as shown in FIG. 6D. Upon adding the prescription or the medication information, the system prompts the administrator to add the related follow up actions. The medication information specified in the prescription is linked with a list of follow up actions. Upon entering the medication information, the list of relevant follow up actions or the follow up action suggested by the clinician is displayed as shown in FIG. 6E. The related follow up information may be added to the patient discharge handout as shown in FIG. 6F. Once the follow up actions are added, the administrator is prompted to schedule the follow up actions as shown in FIG. 6G. The administrator may schedule the follow up actions in accordance with patient's or caretaker's convenience. The patient may select the mode of communication and the frequency at which the reminders need to be sent. Also based on the schedule, the administrator may schedule the appointment with referral doctors, labs etc. This is shown in FIG. 6H and FIG. 6I shows a discharge handout with patient information, prescription indicating medication information, related follow up actions, schedule for the same and the reminder settings preferred by the patient.

In an embodiment a computer-readable medium having on one or more computer readable media for providing decision support is disclosed. The method comprises: a routine for mapping medication information with follow up actions based a predefined relation; and a routine for accessing the related follow up actions upon selecting at least one medication information.

Some of the advantages of the invention include assisting a clinician in providing a clinical decision. Also the invention is used to schedule various follow up actions and track the same. This ensures that required or recommended follow up actions are suggested by the clinician and are followed by the patients. This improves the quality of the patient care and also increases the revenue of the hospitals. Further a database is maintained having various medication information and related follow up actions. This acts as a source of information to other departments. Further the invention simplifies the job of clinician and also increases the efficiency of clinical workflow.

The above-description of the embodiments of the methods and systems has the technical effect of linking medication information with follow up actions. The method and system will act as a decision support to the clinician as related follow up actions are indicated to the clinician.

Thus various embodiments of the invention describe a decision support method and system in clinical environment. Another aspect of the invention is to provide a system and method for linking medication information with follow up actions.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. A computer implemented clinical decision support method comprising the steps of:
mapping medication information with at least one follow up action based on a predefined relation.

2. A method as claimed in claim 1, wherein the medication information includes at least one of: a medication, a diagnosis, a medical intervention, a treatment, a test, a procedure, an exam, a prescription, a referral, a scheduling of an appointment, a completion of an appointment and a discharge.

3. A method as claimed in claim 1, wherein the follow up action includes at least one of: a clinician visit, a lab test, a procedure, an exam, a referral, a scheduling of an appointment, a completion of an appointment, an exercise and a dietary restriction.

4. A method as claimed in claim 1, wherein the method further comprises: customizing the predefined relation based on a requirement for a medication.

5. A method as claimed in claim 1, wherein the method further comprises: providing the at least one corresponding follow up action to a user upon selecting the medication information.

6. A computer implemented prescription support method comprising the steps of:
prescribing medication information;
accessing at least one related follow up action from a database based upon the prescribed medication information; and
indicating the follow up action relevant to the prescribed medication information.

7. A method as claimed in claim 6, further comprising: generating the database, wherein the database is operative to link various medication information with relevant follow up actions.

8. A method as claimed in claim 7, wherein the method further comprises: linking the various medication information with the relevant follow up actions based on predefined relations.

9. A method as claimed in claim 8, wherein the predefined relations are defined based on at least one of patient status, gender, nature of disease, age, criticality of the disease, nature of medication, time period and dosage of medication.

10. A method as claimed in claim 6, wherein the method further comprises: associating the follow up actions and related medication information with a patient's discharge information.

11. A method as claimed in claim 10, wherein the method further comprises: scheduling the related follow up actions.

12. A method as claimed in claim 11, wherein the method further comprises: communicating scheduling information to the patient or a care taker of the patient through at least one of an electronic mail message, a pager message, a telephone communication, a cellular telephone communication, a facsimile communication, an instant message and a pop-up window communication.

13. A method as claimed in claim 6, wherein the method further comprises: tracking the follow up actions with reference to patients, clinician and healthcare services.

14. A method as claimed in claim 6, wherein the method further comprises: linking clinical symptoms associated the prescribed medication information with related follow up actions.

15. A method as claimed in claim 6 wherein the method further comprises: linking patient information with the medication information and the follow up actions.

16. An automated clinical decision support system comprising:
a processor for mapping medication information with corresponding follow up actions based on their relation; and
an indicator for indicating the corresponding follow up actions upon selecting a medication information.

17. A system as claimed in claim 16, wherein the mapping is done using a look up table.

18. A system as claimed in claim 16, wherein the processor is further configured to fetch the related follow up actions from a database.

19. An integrated patient care system comprising:
a data map configured to link various medication information with follow up actions based on a predefined relation;
a processor configured to access follow up actions corresponding to a prescribed medication information from the data map;
an interface for facilitating interaction of the processor with the data map; and
a display for displaying the accessed follow up actions.

20. A system as claimed in claim 19, further comprises a database configured to include patient information and configured to be populated with prescribed medication information.

21. A system as claimed in claim 19, wherein the processor is configured to generate a data map linking medication information with follow up actions.

22. A system as claimed in claim 19, wherein the processor is further configured to automatically schedule the accessed follow up actions.

23. A system as claimed in claim 19, wherein processor is further configured to associate the data map with Electronic Medical Records.

24. A computer-readable medium having one or more computer readable media for providing decision support comprising;
a routine for mapping medication information with follow up actions based on at a predefined relation; and
a routine for accessing the related follow up actions upon selecting at least one medication information.

25. A computer-readable medium as claimed in claim 23, further comprising a routine for populating a database with medication information and corresponding follow up actions.
